(19) United States
(12) Patent Application Publication
(10) Pub. No.: US 2014/0237106 A1
(43) Pub. Date: Aug. 21, 2014

(54) SYSTEMS AND METHODOLOGIES FOR MONITORING SHARED DATA ELEMENTS

(71) Applicant: VARONIS SYSTEMS, INC., New York, NY (US)

(72) Inventors: Yakov FAITELSON, New York, NY (US); Ohad KORKUS, New York, NY (US)

(73) Assignee: VARONIS SYSTEMS, INC., New York, NY (US)

(21) Appl. No.: 13/771,560

(22) Filed: Feb. 20, 2013

(51) Int. Cl. H04L 12/26

(52) U.S. Cl. CPC H04L 43/00
USPC 709/224

(57) ABSTRACT

A method for automatically ascertaining the presence of shared data elements stored on multiple storage resources in a network, the method including automatically ascertaining the presence of multiple storage resources on the network by continuously monitoring the network, for each of the multiple storage resources ascertained to be present in the network, automatically ascertaining the presence of shared data elements associated with data elements stored thereon, and for each of the shared data elements ascertained to be stored on the multiple storage resources in the network, automatically ascertaining at least one property of at least one share designator associated with each of the shared data elements.

### REFERENCE TO RELATED APPLICATIONS

Reference is made to the following patents and patent applications, owned by assignee, the disclosures of which are hereby incorporated by reference:

U.S. Pat. Nos. 7,555,482 and 7,606,801;

U.S. Published Patent Application Nos.: 2007/0244899, 2008/0271157, 2009/0100058, 2009/0119298; 2009/0265780; 2011/0010758; 2011/0060916; 2011/0061093, 2011/0061111, 2011/0184989, 2011/0296490 and 2012/0054283; and

U.S. patent application Ser. Nos. 13/106,023; 13/159,903; 13/303,826 and 13/413,748.

### FIELD OF THE INVENTION

The present invention relates generally to systems and methodologies for monitoring shared data elements in a network.

### BACKGROUND OF THE INVENTION

Shared data elements pose a potential security risk to an enterprise network and therefore must be constantly monitored.

### SUMMARY OF THE INVENTION

The present invention seeks to provide systems and methodologies for monitoring shared data elements in a network.

There is thus provided in accordance with a preferred embodiment of the present invention a method for automatically ascertaining the presence of shared data elements stored on multiple storage resources in a network, the method including automatically ascertaining the presence of multiple storage resources on the network by continuously monitoring the network, for each of the multiple storage resources ascertained to be present in the network, automatically ascertaining the presence of shared data elements associated with data elements stored thereon, and for each of the shared data elements ascertained to be stored on the multiple storage resources in the network, automatically ascertaining at least one property of at least one share designator associated with each of the shared data elements.

Preferably, the method also includes for each of the multiple storage resources ascertained to be present in the network, automatically ascertaining the removal of shared data elements associated with data elements stored thereon by continuously monitoring the network. Preferably, the method also includes, for each of the shared data elements ascertained to have been created, automatically ascertaining modifications of the at least one property of the at least one share designator associated with each the shared data elements.

Preferably, the method also includes, for each of the at least one property of the at least one share designator associated with each the shared data elements ascertained to have been modified, sending an alert to at least one user of the network.

Preferably, the at least one property includes at least one of name of a share designator, network path of the shared data element designated by the share designator, access permissions of a share designator, identification of a person creating, removing or modifying a share designator, and network location of the person creating, removing or changing a share designator at the time of creating, removing or changing the share designator.

There is also provided in accordance with another preferred embodiment of the present invention a method for automatically ascertaining the creation of shared data elements stored on multiple storage resources in a network, the method including automatically ascertaining the presence of the multiple storage resources on the network by continuously monitoring the network, for each of the multiple storage resources ascertained to be present in the network, automatically ascertaining the creation of shared data elements associated with data elements stored thereon by continuously monitoring the network, and for each of the shared data elements ascertained to have been created, automatically ascertaining at least one property of at least one share designator associated with each the shared data element. Preferably, the method also includes, for each of the shared data elements ascertained to have been created, sending an alert to at least one user of the network.

Preferably, the method also includes, for each of the multiple storage resources ascertained to be present in the network, automatically ascertaining the removal of shared data elements associated with data elements stored thereon by continuously monitoring the network. Preferably, the method also includes, for each of the shared data elements ascertained to have been removed, sending an alert to at least one user of the network.

Preferably, the method also includes, for each of the shared data elements ascertained to have been created, automatically ascertaining modifications of the at least one property of the at least one share designator associated with each the shared data elements. Preferably, the method also includes, for each of the at least one property of the at least one share designator associated with each the shared data elements ascertained to have been modified, sending an alert to at least one user of the network.

Preferably, the at least one property includes at least one of name of a share designator, network path of the shared data element designated by the share designator, access permissions of a share designator, identification of a person creating, removing or modifying a share designator, and network location of the person creating, removing or changing a share designator at the time of creating, removing or changing the share designator.

There is further provided in accordance with yet another preferred embodiment of the present invention a system for automatically ascertaining the presence of shared data elements stored on multiple storage resources in a network, the method including network monitoring functionality operative for continuously monitoring the network and automatically ascertaining the presence of the multiple storage resources on the network, storage resource monitoring functionality operative for continuously monitoring the network and automatically ascertaining the presence of shared data elements associated with data elements stored on each of the multiple storage resources ascertained to be present in the network, and shared data element monitoring functionality operative for automatically ascertaining at least one property of at least one share designator associated with each of the shared data elements ascertained to be stored on the multiple storage resources in the network.

Preferably, the storage resource monitoring functionality is also operative for continuously monitoring the network and automatically ascertaining the removal of shared data elements associated with data elements stored on each of the multiple storage resources ascertained to be present in the network.

Preferably, the shared data element monitoring functionality is also operative for automatically ascertaining modifications of the at least one property of the at least one share designator associated with each of the shared data elements ascertained to have been created. Preferably, the system also includes alerting functionality operative, for each of the at least one property of the at least one share designator associated with each the shared data elements ascertained to have been modified, to send an alert to at least one user of the network.

Preferably, the at least one property includes at least one of name of a share designator, network path of the shared data element designated by the share designator, access permissions of a share designator, identification of a person creating, removing or modifying a share designator, and network location of the person creating, removing or changing a share designator at the time of creating, removing or changing the share designator.

There is yet further provided in accordance with still another preferred embodiment of the present invention a system for automatically ascertaining the creation of shared data elements stored on multiple storage resources in a network, the method including network monitoring functionality operative for continuously monitoring the network and automatically ascertaining the presence of the multiple storage resources on the network, storage resource monitoring functionality operative for continuously monitoring the network and automatically ascertaining the creation of shared data elements associated with data elements stored on each of the multiple storage resources ascertained to be present in the network, and shared data element monitoring functionality operative for automatically ascertaining at least one property of at least one share designator associated with each of the shared data elements ascertained to have been created. Preferably, the system also includes alerting functionality operative, for each of the shared data elements ascertained to have been created, to send an alert to at least one user of the network.

Preferably, the storage resource monitoring functionality is also operative for continuously monitoring the network and automatically ascertaining the removal of shared data elements associated with data elements stored on each of the multiple storage resources ascertained to be present in the network. Preferably, the system also includes alerting functionality operative, for each of the shared data elements ascertained to have been removed, to send an alert to at least one user of the network.

Preferably, the shared data element monitoring functionality is also operative for automatically ascertaining modifications of the at least one property of the at least one share designator associated with each of the shared data elements ascertained to have been created. Preferably, the system also includes alerting functionality operative, for each of the at least one property of the at least one share designator associated with each the shared data elements ascertained to have been modified, to send an alert to at least one user of the network.

Preferably, the at least one property includes at least one of name of a share designator, network path of the shared data element designated by the share designator, access permissions of a share designator, identification of a person creating, removing or modifying a share designator, and network location of the person creating, removing or changing a share designator at the time of creating, removing or changing the share designator.

### BRIEF DESCRIPTION OF THE DRAWINGS

The present invention will be understood and appreciated more fully from the following detailed description taken in conjunction with the drawings in which:

FIGS. 1A and 1B are together a simplified pictorial illustration of an example of steps in the operation of a method for automatically ascertaining the presence of shared data elements stored on multiple storage resources in a network, operative in accordance with a preferred embodiment of the present invention;

FIG. 2 is a simplified block diagram illustration of steps in the operation of the method of FIGS. 1A and 1B;

FIGS. 3A and 3B are together a simplified pictorial illustration of another example of steps in the operation of a method for automatically ascertaining the presence of shared data elements stored on multiple storage resources in a network, operative in accordance with another preferred embodiment of the present invention;

FIG. 4 is a simplified block diagram illustration of steps in the operation of the method of FIGS. 3A and 3B; and

FIG. 5 is a simplified block diagram illustration of a system for automatically ascertaining the presence of shared data elements stored on multiple storage resources in a network, constructed and operative in accordance with preferred embodiments of the present invention.

### DETAILED DESCRIPTION OF PREFERRED EMBODIMENTS

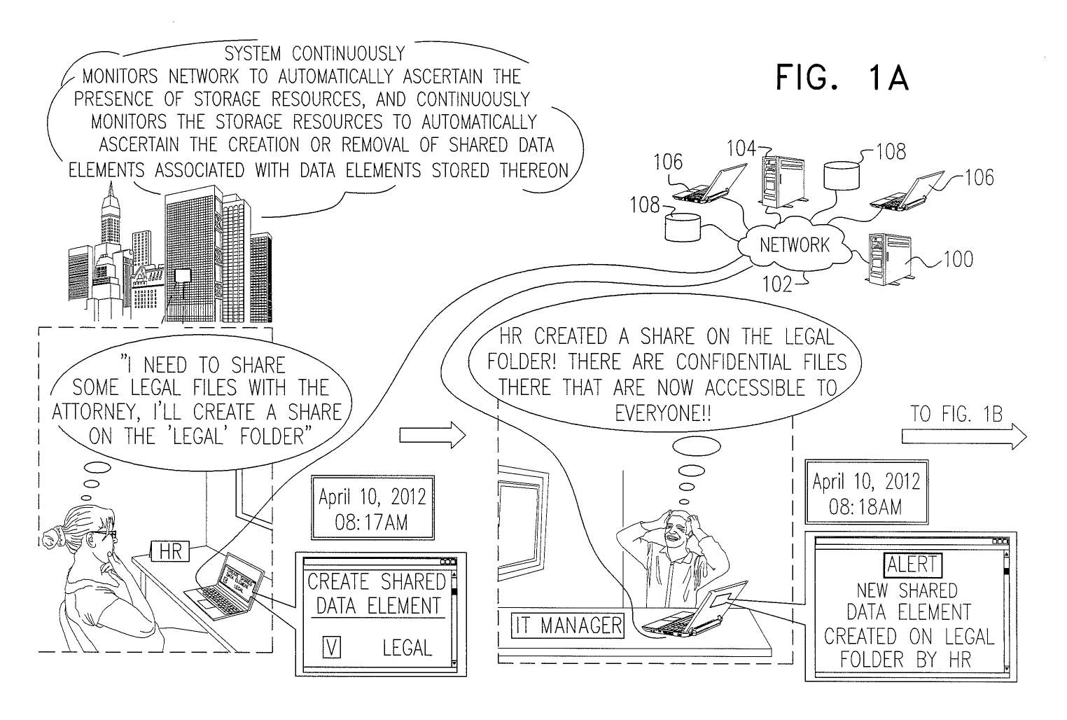

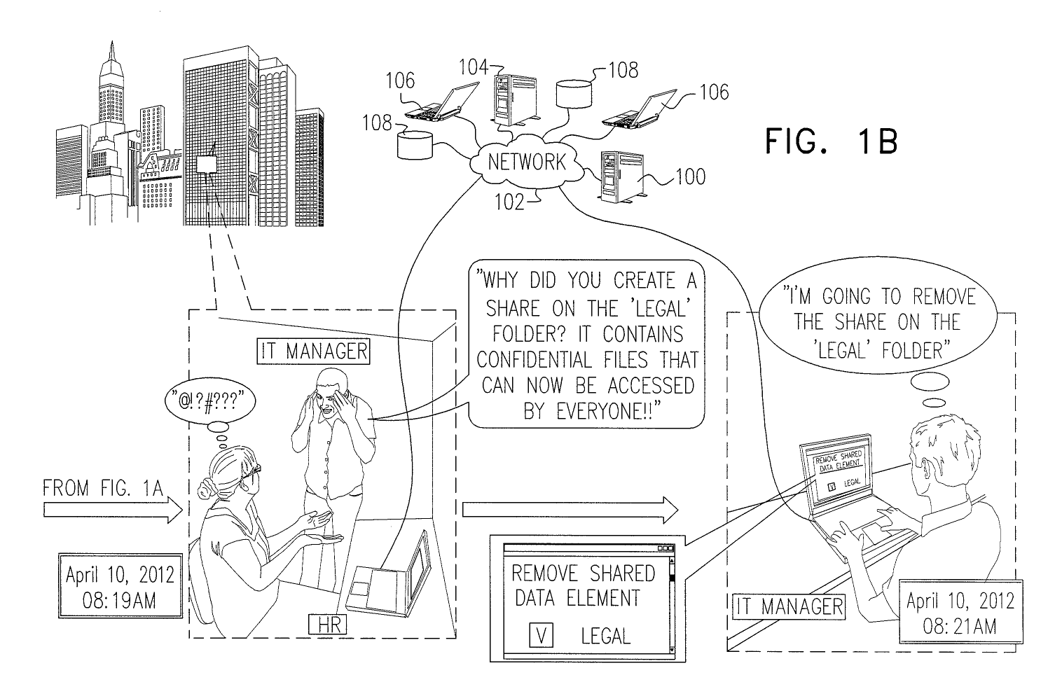

Reference is now made to FIGS. 1A & 1B, which are together a simplified pictorial illustration of an example of steps in the operation of a method for automatically ascertaining the presence of shared data elements stored on multiple storage resources in a network, operative in accordance with a preferred embodiment of the present invention.

The method illustrated in FIGS. 1A & 1B is preferably implemented by a system which typically resides on a server 100 connected to an enterprise-wide computer network 102 having disparate servers 104 and computers 106 connected thereto. Network 102 preferably also comprises a multiplicity of storage resources 108, which typically reside within servers 104 and\or computers 106.

The system of server 100 preferably continuously monitors network 102 to automatically ascertain the presence of storage resources 108. The system of server 100 also preferably continuously monitors storage resources 108 ascertained to be present in network 102 to automatically ascertain the creation or removal of shared data elements associated with data elements stored on storage resources 108.

It is appreciated that the ascertaining the presence of storage resources 108 on network 102 and the creation or removal of shared data elements associated with data elements stored on storage resources 108 may be achieved, for example, by installing a reporting agent on each of servers 104 and computers 106, the agents being operative to report the presence of storage resources 108 and the creation or removal of shared data elements associated with data elements stored on storage resources 108 to the system of server 100.

Alternatively, for example, a group policy may be implemented on network 102, by which the presence of storage resources 108 on network 102 and the creation or removal of shared data elements associated with data elements stored on storage resources 108 are automatically reported to a management server of network 102, such as a Microsoft® Active Directory Server which is then accessible to the system of server 100.

As shown in FIG. 1A, at a particular time, such as on Apr. 10, 2012 at 8:17 AM, an HR manager of a company wishes to share a folder containing legal related files with another employee of the company. Therefore, the HR manager proceeds to create a shared data element designated as ‘legal’ associated with the legal folder, without restricting access to the ‘legal’ shared data element to any particular users of network 102.

Shortly thereafter, such as, for example, at 8:18 AM, the IT Manager of the company receives an alert from the system of server 100, notifying him that a shared data element associated with the legal folder has been created, and that the contents of the legal folder are now accessible to all users of network 102.

Turning now to FIG. 1B, it is shown that immediately thereafter, such as, for example, at 8:19 AM, the IT Manager confronts the HR Manager, demanding to know why she has created a shared data element associated with the legal folder, thereby allowing access to the contents thereof by all users of network 102.

Immediately thereafter, such as, for example, at 8:21 AM, the IT Manager removes the ‘legal’ shared data element associated the legal folder.

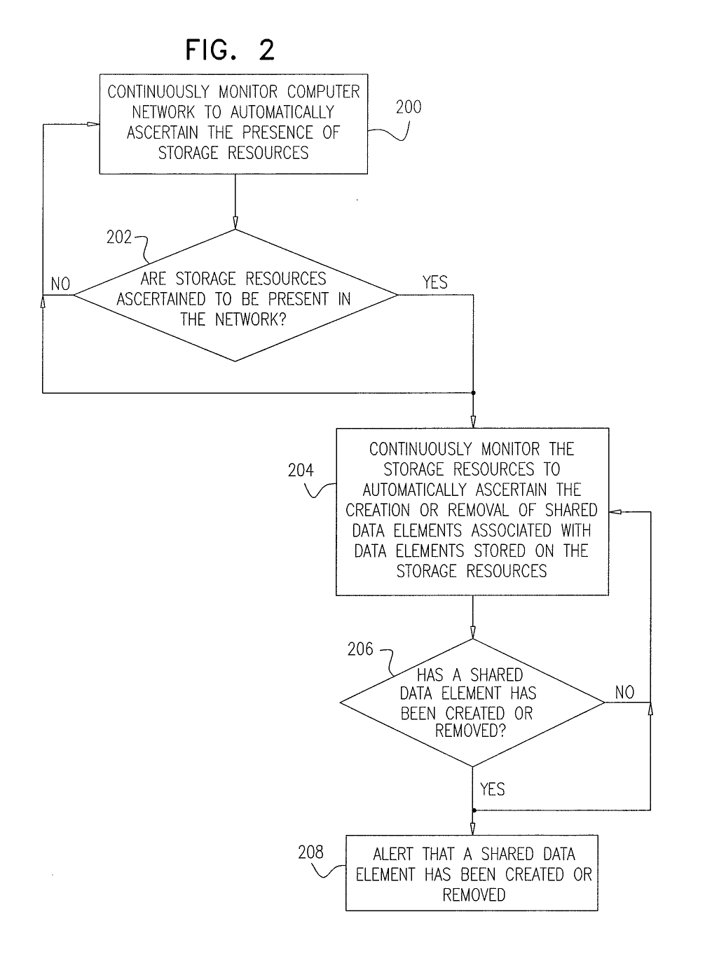

Reference is now made to FIG. 2, is a simplified block diagram illustration of steps in the operation of the method of FIGS. 1A & 1B. As shown in FIG. 2, the method comprises continuously monitoring a computer network to automatically ascertain the presence of storage resources (200). If storage resources are ascertained to be present in the network (202), the method also preferably comprises continuously monitoring the storage resources ascertained to be present in the network to automatically ascertain the creation or removal of shared data elements associated with data elements stored on the storage resources (204).

If a shared data element has been created or removed (206), the method also preferably comprises alerting a manager of the network upon ascertaining that a shared data element has been created or removed (208), thereby enabling the manager to take necessary actions to maintain adequate network security. Such actions may include, for example, removing shared data elements which compromise network security policies.

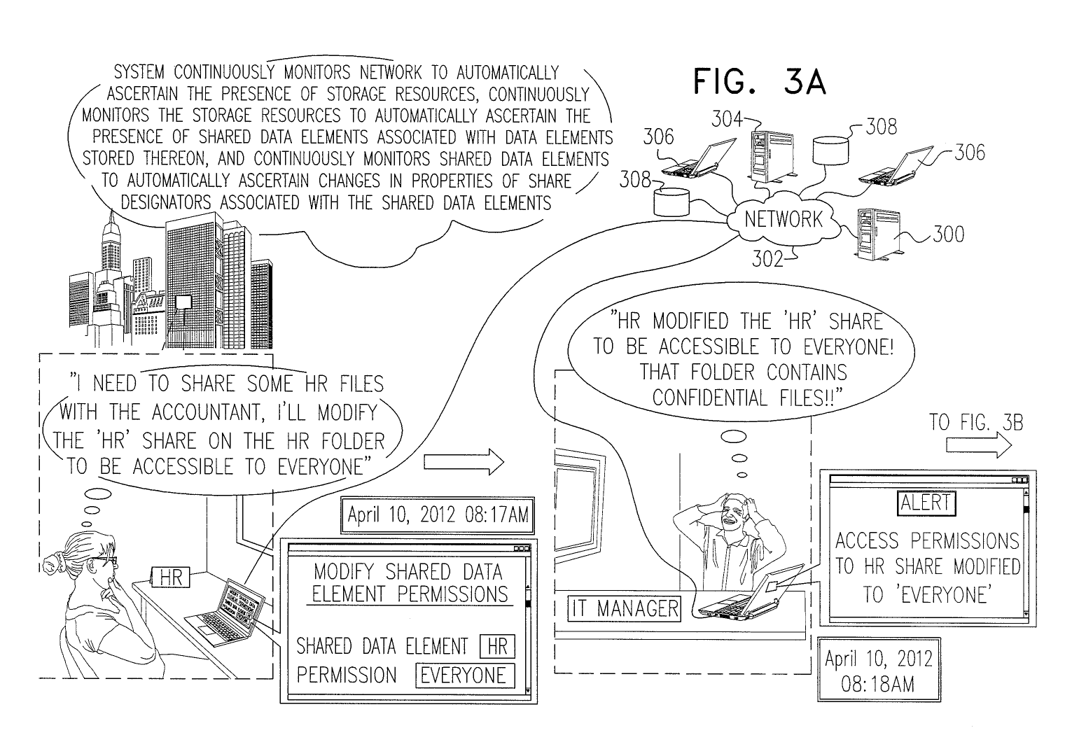

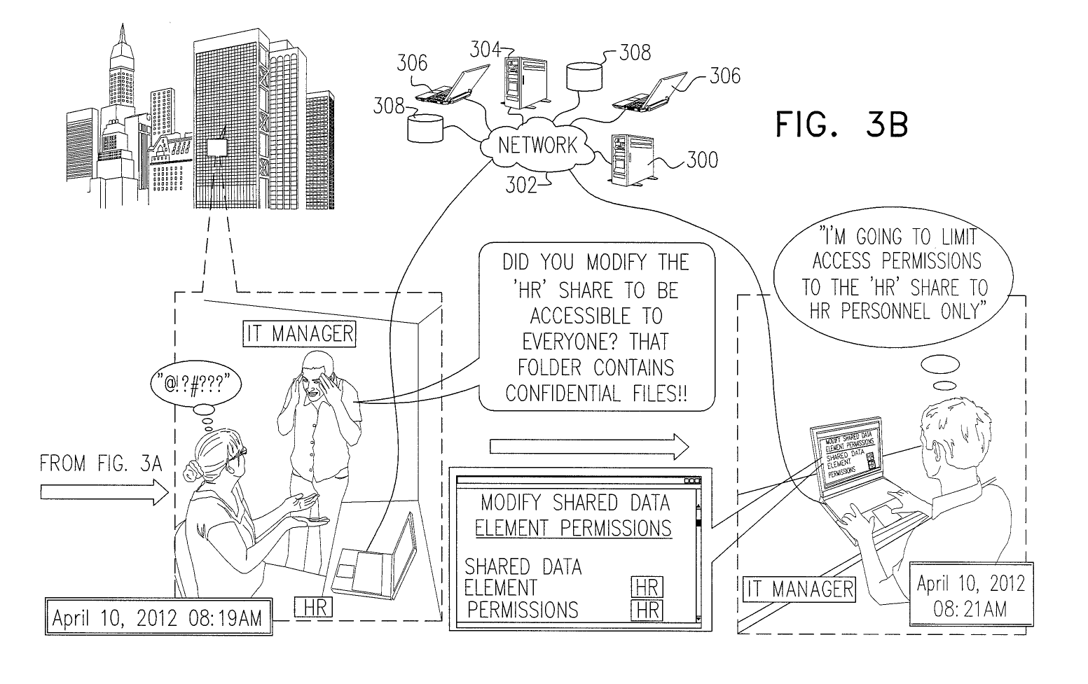

Reference is now made to FIGS. 3A and 3B, which are together a simplified pictorial illustration of another example of steps in the operation of a method for automatically ascertaining the presence of shared data elements stored on multiple storage resources in a network, operative in accordance with another preferred embodiment of the present invention.

The method illustrated in FIGS. 3A & 3B is preferably implemented by a system which typically resides on a server 300 connected to an enterprise-wide computer network 302 having disparate servers 304 and computers 306 connected thereto. Network 302 preferably also comprises a multiplicity of storage resources 308, some of which storage resources preferably being integrated within servers 304 and\or computers 306.

The system of server 300 preferably continuously monitors network 302 to automatically ascertain the presence of storage resources 308. The system of server 300 also preferably continuously monitors storage resources 308 ascertained to be present in network 302 to automatically ascertain the creation or removal of shared data elements corresponding to data elements stored on storage resources 308. The system of server 300 also preferably continuously monitors shared data elements ascertained to be present in network 302 to automatically ascertain modifications of properties of share designators associated with the shared data elements. Properties of a share designator associated with a shared data elements may include, for example, any of the following:

a name of the share designator;

a network path of the shared data element designated by the share designator;

access permissions of the share designator;

identification of a person creating, removing or modifying a share designator; and

network location of the person creating, removing or changing a share designator at the time of creating, removing or changing the share designator.

It is appreciated that the ascertaining the presence of storage resources 308 on network 302, the creation or removal of shared data elements associated with data elements stored on storage resources 308, and the ascertaining of modifications of properties of share designators associated with the shared data elements may be achieved, for example, by installing a reporting agent on each of servers 304 and computers 306, the agents being operative to report the presence of storage resources 308, the creation or removal of shared data elements associated with data elements stored on storage resources 308, and the modifications of properties of share designators associated with the shared data elements, to the system of server 300.

Alternatively, for example, a group policy may be implemented on network 302, by which the presence of storage resources 308 on network 302 and the creation or removal of shared data elements associated with data elements stored on storage resources 308 are automatically reported to a management server of network 302, such as a Microsoft® Active Directory Server which is then accessible to the system of server 300.

As shown in FIG. 3A, at a particular time, such as on Apr. 10, 2012 at 8:17 AM, an HR manager of a company wishes to share a folder containing HR related files with another employee of the company. Therefore, the HR manager proceeds to modify the access permissions of an ‘HR’ share designator associated with a shared HR folder to include access permissions to all users of network 302.

Shortly thereafter, such as, for example, at 8:18 AM, the IT Manager of the company receives an alert from the system of server 300, notifying him that the access permissions of the share designator associated with a shared HR folder have been modified, and that the contents of the HR folder are now accessible to all users of network 302.

Turning now to FIG. 3B, it is shown that immediately thereafter, such as, for example, at 8:19 AM, the IT Manager confronts the HR Manager, demanding to know why she has modified the permissions of the ‘HR’ share designator associated with the shared HR folder, thereby allowing access to the contents thereof by all users of network 302.

Immediately thereafter, such as, for example, at 8:21 AM, the IT Manager modifies the permissions of the ‘HR’ share designator associated with the shared HR folder to limit access to HR personnel only.

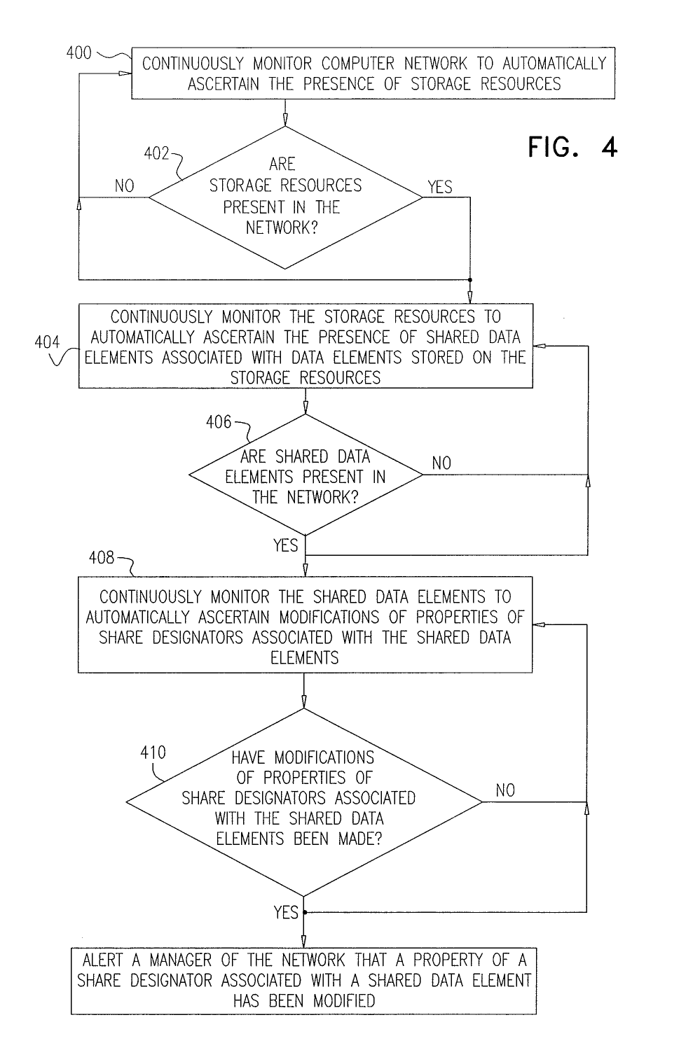

Reference is now made to FIG. 4, which is a simplified block diagram illustration of steps in the operation of the method of FIGS. 3A and 3B. As shown in FIG. 4, the method comprises continuously monitoring a computer network to automatically ascertain the presence of storage resources (400). If storage resources are ascertained to be present in the network (402), the method also preferably comprises continuously monitoring the storage resources ascertained to be present in the network to automatically ascertain the presence of shared data elements associated with data elements stored on the storage resources (404).

If shared data elements are present in the network (406), the method also preferably comprises continuously monitoring the shared data elements ascertained to be present to automatically ascertain modifications of properties of share designators associated with the shared data elements (408).

If modifications of properties of share designators associated with the shared data elements have been made (410), the method also preferably comprises alerting a manager of the network upon ascertaining that a property of a share designator associated with a shared data element has been modified (412), thereby enabling the manager to take necessary actions to maintain adequate network security. Such actions may include, for example, modifying the property of the share designator.

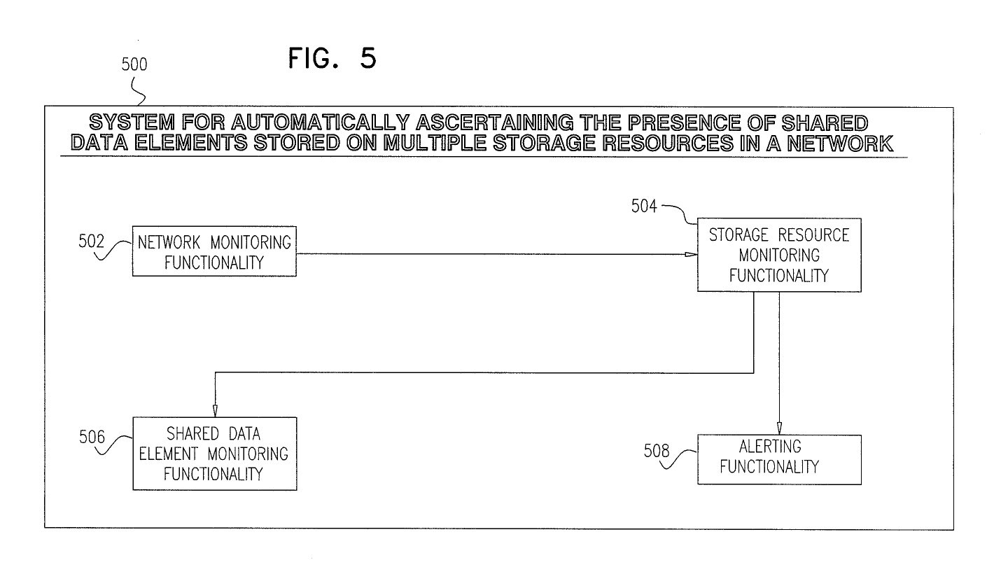

Reference is now made to FIG. 5, which is a simplified block diagram illustration of a system 500 for automatically ascertaining the presence of shared data elements stored on multiple storage resources in a network constructed and operative in accordance with preferred embodiments of the present invention.

Preferably, system 500 includes network monitoring functionality 502 operative to continuously monitor a network to automatically ascertain the presence of storage resources. System 500 also preferably includes storage resource monitoring functionality 504 operative to monitor storage resources ascertained to be present in the network to automatically ascertain the creation or removal of shared data elements associated with data elements stored on the storage resources.

Preferably, system 500 also comprises shared data element monitoring functionality 506 operative for monitoring shared data elements ascertained to be present in network to automatically ascertain modifications of properties of share designators associated with the shared data elements. System 500 also preferably comprises alerting functionality 508 operative to alert a manager of the network upon ascertaining that a shared data element has been created or removed, or that properties of share designators have been modified.

It will be appreciated by persons skilled in the art that the present invention is not limited by what has been particularly shown and described hereinabove. Rather the scope of the present invention includes both combinations and subcombinations of the various features described hereinabove as well as modifications thereof which would occur to persons skilled in the art upon reading the foregoing description and which are not in the prior art.

1. A method for automatically ascertaining the presence of shared data elements stored on multiple storage resources in a network, the method comprising:
automatically ascertaining the presence of said multiple storage resources on said network by continuously monitoring said network;
for each of said multiple storage resources ascertained to be present in said network, automatically ascertaining the presence of shared data elements associated with data elements stored thereon; and
for each of said shared data elements ascertained to be stored on said multiple storage resources in said network, automatically ascertaining at least one property of at least one share designator associated with each of said shared data elements.

2. A method for automatically ascertaining the creation of shared data elements stored on multiple storage resources in a network according to claim 1 and also comprising:
for each of said multiple storage resources ascertained to be present in said network, automatically ascertaining the removal of shared data elements associated with data elements stored thereon by continuously monitoring said network.

3. A method for automatically ascertaining the creation of shared data elements stored on multiple storage resources in a network according to claim 1 and also comprising:
for each of said shared data elements ascertained to have been created, automatically ascertaining modifications of said at least one property of said at least one share designator associated with each said shared data elements.

4. A method for automatically ascertaining the creation of shared data elements stored on multiple storage resources in a network according to claim 3 and also comprising:
for each of said at least one property of said at least one share designator associated with each said shared data elements ascertained to have been modified, sending an alert to at least one user of said network.

5. A method for automatically ascertaining the creation of shared data elements stored on multiple storage resources in a network according to claim 1 and wherein said at least one property includes at least one of:
name of a share designator;
network path of the shared data element designated by the share designator;
access permissions of a share designator;
identification of a person creating, removing or modifying a share designator; and
network location of the person creating, removing or changing a share designator at the time of creating, removing or changing said share designator.

6. A method for automatically ascertaining the creation of shared data elements stored on multiple storage resources in a network, the method comprising:
automatically ascertaining the presence of said multiple storage resources on said network by continuously monitoring said network;
for each of said multiple storage resources ascertained to be present in said network, automatically ascertaining the creation of shared data elements associated with data elements stored thereon by continuously monitoring said network; and
for each of said shared data elements ascertained to have been created, automatically ascertaining at least one property of at least one share designator associated with each said shared data element.

7. A method for automatically ascertaining the creation of shared data elements stored on multiple storage resources in a network according to claim 6 and also comprising:
for each of said shared data elements ascertained to have been created, sending an alert to at least one user of said network.

8. A method for automatically ascertaining the creation of shared data elements stored on multiple storage resources in a network according to claim 6 and also comprising:
for each of said multiple storage resources ascertained to be present in said network, automatically ascertaining the removal of shared data elements associated with data elements stored thereon by continuously monitoring said network.

9. A method for automatically ascertaining the creation of shared data elements stored on multiple storage resources in a network according to claim 8 and also comprising:
for each of said shared data elements ascertained to have been removed, sending an alert to at least one user of said network.

10. A method for automatically ascertaining the creation of shared data elements stored on multiple storage resources in a network according to claim 6 and also comprising:
for each of said shared data elements ascertained to have been created, automatically ascertaining modifications of said at least one property of said at least one share designator associated with each said shared data elements.

11. A method for automatically ascertaining the creation of shared data elements stored on multiple storage resources in a network according to claim 10 and also comprising:
for each of said at least one property of said at least one share designator associated with each said shared data elements ascertained to have been modified, sending an alert to at least one user of said network.

12. A method for automatically ascertaining the creation of shared data elements stored on multiple storage resources in a network according to claim 6 and wherein said at least one property includes at least one of:
name of a share designator;
network path of the shared data element designated by the share designator;
access permissions of a share designator;
identification of a person creating, removing or modifying a share designator; and
network location of the person creating, removing or changing a share designator at the time of creating, removing or changing said share designator.

13. A system for automatically ascertaining the presence of shared data elements stored on multiple storage resources in a network, the system comprising:
network monitoring functionality operative for continuously monitoring said network and automatically ascertaining the presence of said multiple storage resources on said network;
storage resource monitoring functionality operative for continuously monitoring said network and automatically ascertaining the presence of shared data elements associated with data elements stored on each of said multiple storage resources ascertained to be present in said network; and
shared data element monitoring functionality operative for automatically ascertaining at least one property of at least one share designator associated with each of said shared data elements ascertained to be stored on said multiple storage resources in said network.

14. A system for automatically ascertaining the creation of shared data elements stored on multiple storage resources in a network according to claim 13 and wherein said storage resource monitoring functionality is also operative for continuously monitoring said network and automatically ascertaining the removal of shared data elements associated with data elements stored on each of said multiple storage resources ascertained to be present in said network.

15. A system for automatically ascertaining the creation of shared data elements stored on multiple storage resources in a network according to claim 13 and wherein said shared data element monitoring functionality is also operative for automatically ascertaining modifications of said at least one property of said at least one share designator associated with each of said shared data elements ascertained to have been created.

16. A system for automatically ascertaining the creation of shared data elements stored on multiple storage resources in a network according to claim 15 and also comprising alerting functionality operative, for each of said at least one property of said at least one share designator associated with each said shared data elements ascertained to have been modified, to send an alert to at least one user of said network.

17. A system for automatically ascertaining the creation of shared data elements stored on multiple storage resources in a network according to claim 13 and wherein said at least one property includes at least one of:
name of a share designator;
network path of the shared data element designated by the share designator;
access permissions of a share designator;
identification of a person creating, removing or modifying a share designator; and
network location of the person creating, removing or changing a share designator at the time of creating, removing or changing said share designator.

18. A system for automatically ascertaining the creation of shared data elements stored on multiple storage resources in a network, the system comprising:
network monitoring functionality operative for continuously monitoring said network and automatically ascertaining the presence of said multiple storage resources on said network;
storage resource monitoring functionality operative for continuously monitoring said network and automatically ascertaining the creation of shared data elements associated with data elements stored on each of said multiple storage resources ascertained to be present in said network; and
shared data element monitoring functionality operative for automatically ascertaining at least one property of at least one share designator associated with each of said shared data elements ascertained to have been created.

19. A system for automatically ascertaining the creation of shared data elements stored on multiple storage resources in a network according to claim 18 and also comprising alerting functionality operative, for each of said shared data elements ascertained to have been created, to send an alert to at least one user of said network.

20. A system for automatically ascertaining the creation of shared data elements stored on multiple storage resources in a network according to claim 18 and wherein said storage resource monitoring functionality is also operative for continuously monitoring said network and automatically ascertaining the removal of shared data elements associated with data elements stored on each of said multiple storage resources ascertained to be present in said network.

21. A system for automatically ascertaining the creation of shared data elements stored on multiple storage resources in a network according to claim 20 and also comprising alerting functionality operative, for each of said shared data elements ascertained to have been removed, to send an alert to at least one user of said network.

22. A system for automatically ascertaining the creation of shared data elements stored on multiple storage resources in a network according to claim 18 and wherein said shared data element monitoring functionality is also operative for automatically ascertaining modifications of said at least one property of said at least one share designator associated with each of said shared data elements ascertained to have been created.

23. A system for automatically ascertaining the creation of shared data elements stored on multiple storage resources in a network according to claim 22 and also comprising alerting functionality operative, for each of said at least one property of said at least one share designator associated with each said shared data elements ascertained to have been modified, to send an alert to at least one user of said network.

24. A system for automatically ascertaining the creation of shared data elements stored on multiple storage resources in a network according to claim 18 and wherein said at least one property includes at least one of:
name of a share designator;
network path of the shared data element designated by the share designator;
access permissions of a share designator;
identification of a person creating, removing or modifying a share designator; and
network location of the person creating, removing or changing a share designator at the time of creating, removing or changing said share designator.
